(19) United States
(12) Patent Application Publication
(10) Pub. No.: US 2002/0068594 A1
(43) Pub. Date: Jun. 6, 2002

(54) METHOD AND APPARATUS FOR INDICATING CALL-TYPE IN DISADVANTAGED MODE

(76) Inventors: JAVOR KOLEV, CARY, NC (US); DAVID GREGORY, CARY, NC (US); GREGORY DUNKO, CARY, NC (US); MARK RANTA, APEX, NC (US)

Correspondence Address: MOORE & VAN ALLEN, PLLC, 2200 W MAIN STREET, SUITE 800, DURHAM, NC, 27705, US

(21) Appl. No.: 09/144,024

(22) Filed: Aug. 31, 1998

(51) Int. Cl. H04B 7/00; H04Q 7/20; H04M 1/00; H04B 1/38

(52) U.S. Cl. 455/517; 455/550

(57) ABSTRACT

A method is provided for use in a radio-communication system having a first radio-communication device and a second radio-communication device, the second radio-communication device capable of operating in a disadvantaged mode wherein only a one-way communication link is possible from the first radio-communication device to the second radio-communication device. The method includes the steps of transmitting a paging message from the first radio-communication device to the second radio-communication device with the second radio-communication device operating in the disadvantaged mode, receiving the paging message at the second radio-communication devices, and displaying a user prompt at the second radio-communication device representative of a request to establish a particular type of communication between the radio-communication devices as an incident of receiving the paging message. A radio-communication device is also provided having a program operating in a programmable computational apparatus to operate the programmable computational apparatus to carry out the method.

### FIELD OF THE INVENTION

The present invention is directed to a method and apparatus for indicating the type of call being sent from a first radio-communication device to a second radio-communication device, and in particular, a method and apparatus for indicating the type of call being sent from a first radio-communication device to a second radio-communication device with the second radio-communication device in a disadvantaged mode of operation relative to the first radio-communication device.

### BACKGROUND OF THE INVENTION

Conventionally, a radio-communication system has a small number of large transmitter/receivers which are in communication with a large number of small transmitter/receivers which are designed to be carried by hand. For simplicity, the large transmitter/receivers will be referred to as first radio-communication devices, while the smaller transmitter/receivers will be referred to as second radio-communication devices.

A characteristic common to radio-communication systems is that they have a limited range. That is to say, for any two radio-communication devices, the maximum distance at which the radio-communication devices are able to communicate with each other (i.e. maintain a communications link) is limited by the coding gain and transmission power of the devices.

Quite obviously, to maximize the portability of the second radio-communication devices, it is necessary to minimize the size of the device. Because of this need to decrease the size of the device, it is necessary to use a smaller transmitter and power supply in the second radio-communication device than can be used in the first radio-communication device. In doing so, the maximum range at which the first and second radio-communication devices can transmit messages back and forth may be decreased.

However, not all communications to be carried on between the second radio-communication device and the first radio-communication device require a two-way communication link. For example, the first radio-communication device can transmit broadcast information to the second radio-communication device on a one-way communication link. Not limited by the size of the transmitter or power supply of the second radio-communication device, the maximum distance for this communication between the first and second radio-communication devices is only limited by the size of the transmitter and power supply of the first radio-communication device, which is typically several orders of magnitude larger than that used in the second radio-communication device.

Within the industry, the two-way and one-way communication links are termed the “advantaged and disadvantaged” modes of operation. Specifically, the advantaged mode of operations occurs where the second radio-communication device can receive both low and high power signals from the first radio-communication device, and can communicate with the first radio-communication device along a return low-power channel. The disadvantaged mode of operations occurs where the second radio-communication device can receive only the high power signals, and cannot communicate with the first radio-communication device along a return low-power channel.

While a considerable number of communications could occur between the first and second radio-communication devices even in the disadvantaged mode of operation, a significant obstacle exists to utilizing this potential fully. Conventionally, in the advantaged mode of operation, the second radio-communication device receives information from the first radio-communication device indicating which type of message (voice call, fax call, data call, etc.) is being transmitted from the first radio-communication device. In the disadvantaged mode, however, no call-type indicator is typically provided, such information usually being transmitted to the second radio-communication device only after the second radio-communication device sends a response signal along a return channel to the first radio-communication device in response to a paging signal.

Consequently, a user of a second radio-communication device which is in the disadvantaged mode must move the second radio-communication device so that it can achieve an advantaged mode of operation in order to determine whether the incoming call is of a voice, fax, or data type. However, upon arrival at a position sufficient to permit advantaged mode operation, the user may not have the necessary peripherals (fax machine or computer or other accessories) with him or her to receive the incoming call or message. Consequently, the user may be required to return to the previous location to receive the call from the first radio-communication device. Quite obviously, this can be frustrating for the user, and diminish the user's satisfaction with the cellular system which he or she has contracted to use.

### SUMMARY OF THE INVENTION

According to an aspect of the present invention, a method is provided for use in a radio-communication system having a first radio-communication device and a second radio-communication device, the second radio-communication device capable of operating in a disadvantaged mode wherein only a one-way communication link is possible from the first radio-communication device to the second radio-communication device. The method includes the steps of transmitting a paging message from the first radio-communication device to the second radio-communication device with the second radio-communication device operating in the disadvantaged mode, receiving the paging message at the second radio-communication device, and activating a user indicator at the second radio-communication device representative of a request to establish a particular type of communication between the first and second radio-communication devices as an incident of receiving the paging message.

The step of transmitting a paging message may include the step of transmitting a paging message having a first string which is representative of a request to establish a particular type of communication between the first and the second radio-communication devices.

Moreover, the step of transmitting a paging message may include the step of transmitting a paging message having a first string which is representative of a request to establish a facsimile communication between the first radio-communication device and the second radio-communication device, and the step of activating a user indicator may include the step of activating a facsimile communication user indicator at the second radio-communication device.

Moreover, the step of transmitting a paging message may include the step of transmitting a paging message having a first string which is representative of a request to establish a data communication between the first radio-communication device and the second radio-communication device, and the step of activating a user indicator may include the step of activating a data communication user indicator at the second radio-communication device.

Additionally, the step of transmitting a paging message may include the step of transmitting a paging message having a first string which is representative of a request to establish a voice communication between the first radio-communication device and the second radio-communication device, and the step of activating a user indicator may include the step of activating a voice communication user indicator at the second radio-communication device.

Also, the step of transmitting a paging message may include the step of transmitting a paging message having a first string which is representative of a request to establish a particular type of communication between the first and the second radio-communication devices and a second string which is representative of a first identification code, and the step of activating a user indicator may include the step of activating a user indicator at the second radio-communication device representative of a request to establish a particular type of communication between the first and the second radio-communication devices only if the first identification code contained in the paging message matches a second identification code stored in the second radio-communication device.

According to another aspect of the present invention, a receiving radio-communication device is provided. The receiving radio-communication device includes a receiver to receive a paging message from a sending radio-communication device with the receiving radio-communication device operating in a disadvantaged mode relative to the sending radio-communication device wherein only a one-way communication link is possible from the sending radio-communication device to the receiving radio-communication device. Further, the receiving radio-communication device has a programmable computational apparatus selectively coupleable to the receiver, and an output assembly device selectively coupleable to the programmable computational apparatus. A program operates in the programmable computational apparatus to control the programmable computational apparatus to control the receiver to receive a paging message from a sending radio-communication device, and to control the output device to activate a user indicator representative of a request to establish a particular type of communication between the sending and receiving radio-communication devices as an incident of receiving the paging message.

With the paging message including a first string which is representative of a request to establish a particular type of communication between the sending radio-communication device and the receiving radio-communication device, the program may operate in the programmable computational apparatus to control the programmable computational apparatus to control the output device to activate a user indicator representative of a request to establish a particular type of communication between the sending and receiving radio-communication devices.

With the paging message including a first string which is representative of a request to establish a particular type of communication between the sending radio-communication device and the receiving radio-communication device and a second string which is representative of a first identification code, the radio-communication device may include a memory selectively coupleable to the programmable computational apparatus and having a site in which is stored a second identification code. The program may operate in the programmable computational apparatus to control the programmable computational apparatus to retrieve the second identification code from the memory, to determine if the first identification code matches the second identification code, and to control the output device to activate a user indicator representative of a request to establish a particular type of communication between the sending and receiving radio-communication devices only if the first identification code matches the second identification code.

### BRIEF DESCRIPTION OF THE DRAWINGS

FIG. 1 is a schematic representation of a system with a first radio-communication device and a second radio-communication device capable of operating in a disadvantaged mode and an advantaged mode relative to the first radio-communication device;

FIG. 2 is a block diagram illustrating a method according to the present invention for informing the user of a second radio-communication device what type of call is being received with the second radio-communication device in a disadvantaged mode of operation relative to a first radio-communication device;

FIG. 3 is a schematic representation of a second radio-communication device used in the method according to the present invention;

FIG. 4 is a schematic representation of a second radio-communication device displaying an alpha-numeric indication of a request for a voice call with the second radio-communication device in a disadvantaged mode relative to a first radio-communication device; and

FIG. 5 is a schematic representation of a second radio-communication device displaying an alpha-numeric indication of a request for a non-voice type of communication, e.g., short message or data or fax call, with the second radio-communication device in a disadvantaged mode of operation relative to a first radio-communication device.

### DETAILED DESCRIPTION OF THE PREFERRED EMBODIMENT

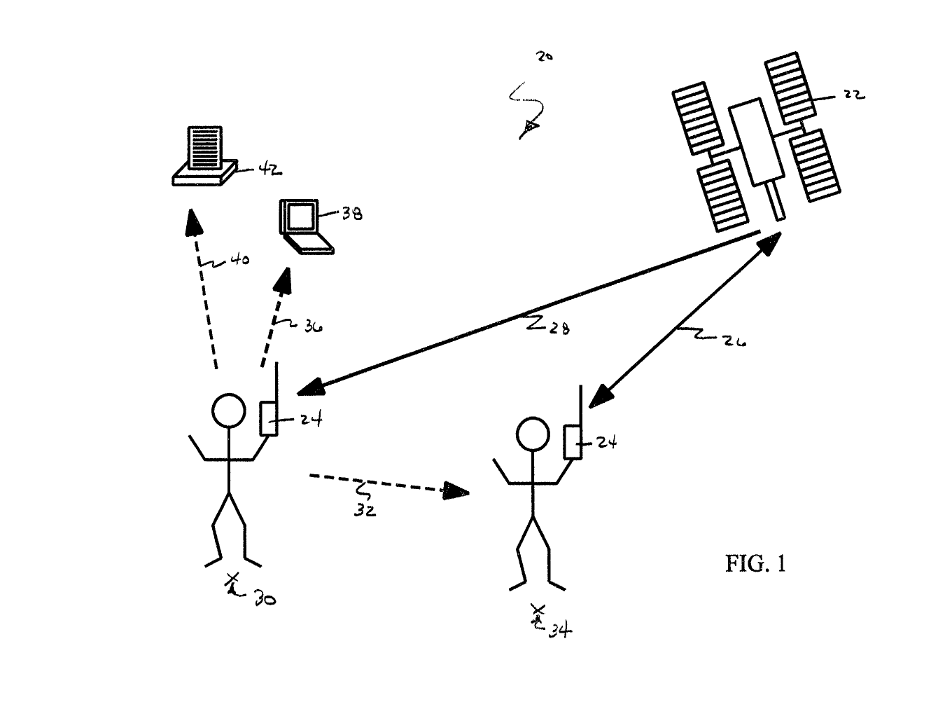

FIG. 1 shows a system 20 for radio communication between a first radio-communication device/satellite 22 and a second radio-communication device 24. The first radio-communication/satellite 22 may be part of a cellular satellite communication system, such as the Asia cellular satellite communication system. The second radio-communication device 24 shown may be one of a plurality of second radio-communication devices which are in communication with the first radio-communication device 22.

Communication occurs between the first radio-communication device 22 and the second radio-communication device 24 in one of two modes: advantaged and disadvantaged. The difference between the advantaged and disadvantaged modes of operation, as explained before, is dependent upon whether one-way or two-way communication is possible between the second radio-communication device 24 and the first radio-communication device 22. In FIG. 1, an advantaged mode of operation is shown by a double-headed arrow 26, wherein two-way communication is possible between the second radio-communication device 24 and the first radio-communication device 22. A one-way, disadvantaged mode of operation is shown by a single-headed arrow 28 in FIG. 1, indicating that transmission is possible only from the first radio-communication device 22 to the second radio-communication device 24.

Assuming that the second radio-communication device 24 is at a position 30, and a paging signal is sent from the first radio-communication device 22 to the second radio-communication device 24, the user has several options. First, the user could move, as indicated by a dashed line 32, to a position 34, wherein two-way, advantaged mode communication is possible between the first radio-communication device 22 and the second radio-communication device 24. This would be particularly necessary if the incoming call type is a voice call or other call which does not require the use of special accessories between the second radio-communication device 24 and the first radio-communication device 22. Second, the user could move the second radio-communication device 24 into association with a computer 38, as represented by a dashed arrow 36, and then activate an advantaged mode of operation so as to receive, for example, a data call. Third, the user could move the second radio-communication device 24, as shown by a dashed arrow 40, into association with a fax machine 42, and then achieve an advantaged mode of operation to receive an incoming fax call.

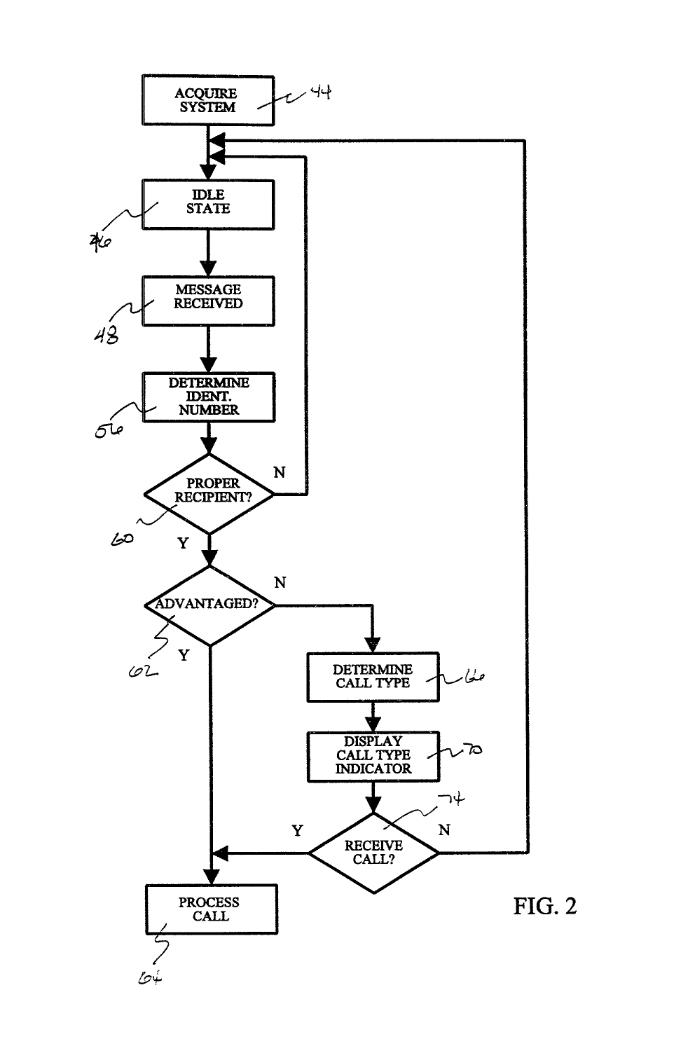

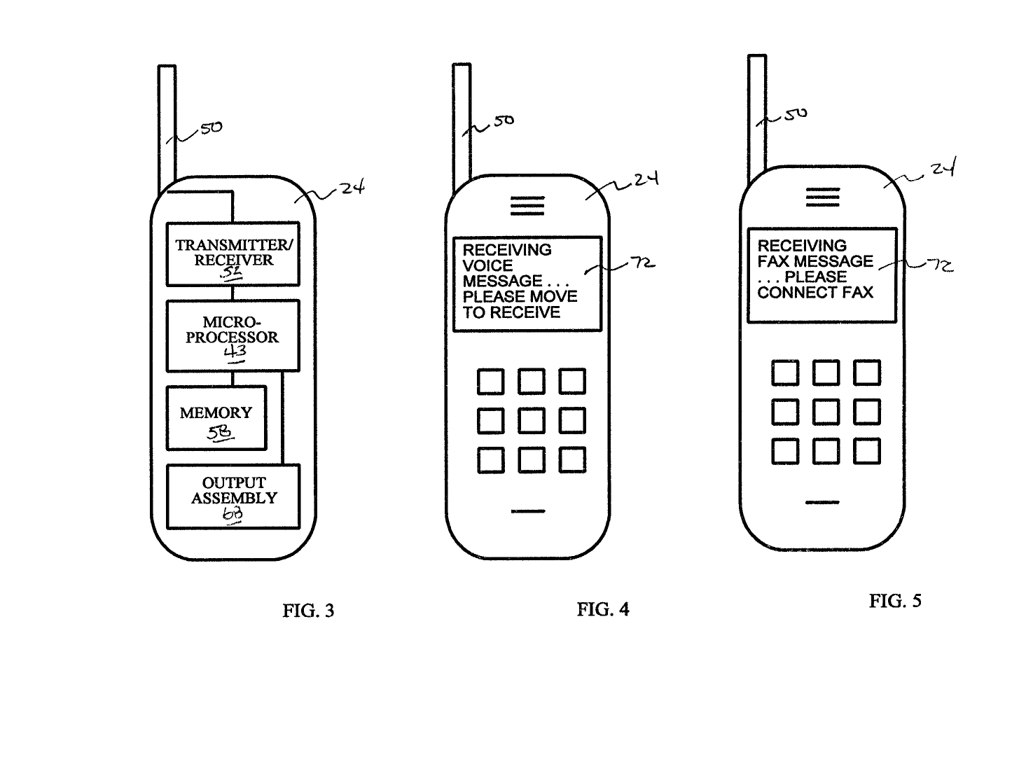

Conventionally, a user could decide whether he or she wanted to receive the call, and if so whether it was necessary to move to its position 34 or to associate the second radio-communication device 24 with either a computer 38 or a fax machine 42 only after the user had moved the second radio-communication device 24 to the position 34 so as to achieve an advantaged mode of communication with the first radio-communication device 22. The method according to the present invention, as illustrated in FIG. 2 and as performed by a program operating in a microprocessor 43 of the second radio-communication device 24 as shown in FIG. 3, allows a user to determine whether it is necessary to move to the position 34 or obtain peripherals 38, 42 without having to first move to the position 34.

In general terms, the method for use in a radio-communication system (such as 20) including a first radio-communication device (such as 22) and a second radio-communication device (such as 24) capable of operating in a disadvantaged mode of operation with the first radio-communication device has three steps. First, the first radio-communication device 22 transmits a paging message to the second radio-communication device 24 operating in the disadvantage mode. Second, the second radio-communication device 24 receives the paging message. Third, the second radio-communication device 24 activates a user indicator representative of whether the first radio-communication device 22 is requesting a voice or non-voice (e.g., data or fax) radio-communication with the second radio-communication device 24.

Specifically, the method requires that the second radio-communication device 24 acquire a communication with the first radio-communication device 22 at a block 44. The second radio-communication device 24 remains in an idle state at a block 46 until a paging message is received from the first radio-communication device 22.

At a block 48, the second radio-communication device 24 receives a paging message from the first radio-communication device 22. The paging message may contain one or more bits indicating the identification number of the second radio-communication device 24 with which the first radio-communication device 22 wishes to communicate. According to the present invention, the paging message will also include one or more bits indicating a particular type of communication that the first radio-communication device 22 wishes to establish with the desired second radio-communication device 24.

In particular, a high powered alerting channel may be used to transmit a 53 bit paging message. As will be recognized by one of ordinary skill in the art, the first 50 bits of such a paging message are conventionally devoted to the identification code or number of the second radio-communication device paged, leaving the last three bits for use as the call-type indicator. To promote standardization, the information transfer capability values for the cellular system used (in this case, the Asia cellular satellite system) are used for the call-type indicator values. Accordingly, a three bit string of 000 indicates a speech call, a string of 001 indicates an unrestricted digital information signal, a string of 010 indicates an audio message, and a string of 011 indicates a fax call.

Referring additionally to FIG. 3, when an antenna 50 and transmitter/receiver 52 receive a paging message from the first radio-communication device 22, they pass this message along to the microprocessor or programmable computational apparatus 43, which first determines the identification number associated with the paging message at a block 56. The microprocessor 43 then retrieves a second identification number from a memory 58 in the second radio-communication device 24 and compares this second radio-communication device identification number with the identification number associated with the paging message. The microprocessor 43 makes the determination at a block 60 whether the message identification number and the second radio-communication device identification number match. If the identification number associated with the paging message does not match the identification number for the specific second radio-communication device unit 24, then the microprocessor would return the second radio-communication device 24 to the idle state at the block 46 until a new message is received at the block 48.

If the identification number for the paging message matches the identification number for the second radio-communication device 24, then the microprocessor 43 determines at block 62 whether the second radio-communication device 24 is in an advantaged or a disadvantaged mode of operation, a condition updated continuously by the second radio-communication device 24 according to the received signal strength. If the phone is already in an advantaged mode of operation, then the call will be processed at a block 64.

If, however, the microprocessor 43 determines that the second radio-communication device 24 is in a disadvantaged mode of operation, then at a block 66, the microprocessor 43 analyzes the incoming paging message for the three bit call-type indicator associated therewith. Dependent upon the call-type indicator received, the microprocessor 43 controls an output assembly 68 to activate one of a variety of call-type user indicators at a block 70. The output assembly 68 may activate either an audio or a video display of the incoming call. For example, the output assembly 68 may use light, sound, or an alpha-numeric message, as an indicator that the incoming call is either a voice, data, or fax call.

As illustrated in FIGS. 4 and 5, the second radio-communication device 24 has an output assembly 68 including an alpha-numeric display or LCD crystal 72. When the second radio-communication device 24 is in a disadvantaged mode of operation, and the incoming call is a voice call, then as shown in FIG. 4, the second radio-communication device 24 may display a message “RECEIVING VOICE MESSAGE . . . PLEASE MOVE TO RECEIVE” on the display 72. The user will then know that he or she merely needs to adjust the antenna 50 or move from the position 30 to the position 34 wherein an advantaged mode of operation can be achieved with the second radio-communication device 24. On the other hand, if the incoming call is a non-voice call, such as a fax call, then the second radio-communication device 24 displays a message such as in FIG. 5; “RECEIVING FAX MESSAGE . . . PLEASE CONNECT FAX”.

After reviewing the message displayed, the user of the second radio-communication device 24 can determine at a block 74 whether or not to receive the call. For example, if the message displayed is that in FIG. 5, the user can move to associate the phone with the fax machine 42 and achieve an advantaged mode of operation. On the other hand, if the user does not have access to a fax machine 42, for example, the user can ignore the call.

As a consequence of the foregoing method, it is not necessary for the user to move from the position 30, wherein the second radio-communication device 24 is in a disadvantaged mode of operation with the first radio-communication device 22, to a position 34, wherein the second radio-communication device 24 is in an advantaged mode of operation with the first radio-communication device 22, just to determine what type of incoming call is being processed. As a further consequence, the full potential of the operation in the disadvantaged mode may be realized.

Still other aspects, objects, and advantages of the present invention can be obtained from a study of the specification, the drawings, and the appended claims.

We claim:

1. A method for use in a radio-communication system comprising a first radio-communication device and a second radio-communication device, the second radio-communication device capable of operating in a disadvantaged mode wherein only a one-way communication link is possible from the first radio-communication device to the second radio-communication device, the method comprising the steps of:
transmitting a paging message from the first radio-communication device to the second radio-communication device with the second radio-communication device operating in the disadvantaged mode;
receiving the paging message at the second radio-communication device; and
activating a user indicator at the second radio-communication device representative of a request to establish a particular type of communication between the first and second radio-communication devices as an incident of receiving the paging message.

2. The method according to claim 1, wherein the step of transmitting a paging message comprises the step of transmitting a paging message having a first string which is representative of a request to establish a particular type of communication between the first and the second radio-communication devices.

3. The method according to claim 2, wherein:
the step of transmitting a paging message comprises the step of transmitting a paging message having a first string which is representative of a request to establish a facsimile communication between the first radio-communication device and the second radio-communication device; and
the step of activating a user indicator comprises the step of activating a facsimile communication user indicator at the second radio-communication device.

4. The method according to clam 2, wherein:
the step of transmitting a paging message comprises the step of transmitting a paging having a first string which is representative of a request to establish a data communication between the first radio-communication device and the second radio-communication device; and
the step of activating a user indicator comprises the step of activating a data communication user indicator at the second radio-communication device.

5. The method according to claim 2, wherein:
the step of transmitting a paging message comprises the step of transmitting a paging message having a first string which is representative of a request to establish a voice communication between the first radio-communication device and the second radio-communication device; and
the step of activating a user indicator comprises the step of activating a voice communication user indicator at the second radio-communication device.

6. The method according to claim 2, wherein:
the step of transmitting a paging message comprises the step of transmitting a paging message having a first string which is representative of a request to establish a particular type of communication between the first and the second radio-communication devices and a second string which is representative of a first identification code; and
the step of activating a user indicator comprises the step of activating a user indicator at the second radio-communication device representative of a request to establish a particular type of communication between the first and the second radio-communication devices only if the first identification code contained in the paging message matches a second identification code stored in the second radio-communication device.

7. A receiving radio-communication device comprising:
a receiver to receive a paging message from a sending radio-communication device with the receiving radio-communication device operating in a disadvantaged mode relative to the sending radio-communication device wherein only a one-way communication link is possible from the sending radio-communication device to the receiving radio-communication device;
a programmable computational apparatus selectively coupleable to the receiver;
an output assembly device selectively coupleable to the programmable computational apparatus; and
a program operating in the programmable computational apparatus to control the programmable computational apparatus to control the receiver to receive a paging message from a sending radio-communication device, and to control the output device to activate a user indicator representative of a request to establish a particular type of communication between the sending and receiving radio-communication devices as an incident of receiving the paging message.

8. The receiving radio-communication device according to claim 6, wherein:
the paging message comprises a first string which is representative of a request to establish a non-voice communication between the sending radio-communication device and the receiving radio-communication device; and
the program operates in the programmable computational apparatus to control the programmable computational apparatus to control the output device to activate a user indicator representative of a request to establish a non-voice communication between the sending and receiving radio-communication devices.

9. The receiving radio-communication device according to claim 6, wherein:
the paging message comprises a first string which is representative of a request to establish a voice communication between the sending radio-communication device and the receiving radio-communication device; and
the program operates in the programmable computational apparatus to control the programmable computational apparatus to control the output device to activate a user indicator representative of a request to establish a voice communication between the sending and receiving radio-communication devices.

10. The receiving radio-communication device according to claim 6, the paging message comprising a first string which is representative of a request to establish a particular type of communication between the sending radio-communication device and the receiving radio-communication device and a second string which is representative of a first identification code, the radio-communication device further comprising:
a memory selectively coupleable to the programmable computational apparatus and having a site in which is stored a second identification code,
the program operating in the programmable computational apparatus to control the programmable computational apparatus to retrieve the second identification code from the memory, to determine if the first identification code matches the second identification code, and to control the output device to activate a user indicator representative of a request to establish a particular type of communication between the sending and receiving radio-communication devices only if the first identification code matches the second identification code.
